(19) United States
(12) Patent Application Publication
(10) Pub. No.: US 2020/0409991 A1
(43) Pub. Date: Dec. 31, 2020

(54) INFORMATION PROCESSING APPARATUS AND METHOD, AND PROGRAM

(71) Applicant: FUJIFILM Corporation, Tokyo (JP)

(72) Inventors: Kei YAMAJI, Tokyo (JP); Tetsuya MATSUMOTO, Tokyo (JP); Shinichiro SONODA, Tokyo (JP); Nobuya TANAKA, Tokyo (JP); Hirotoshi YOSHIZAWA, Tokyo (JP)

(73) Assignee: FUJIFILM Corporation, Tokyo (JP)

(21) Appl. No.: 16/904,018

(22) Filed: Jun. 17, 2020

(30) Foreign Application Priority Data
Jun. 28, 2019 (JP) 2019-121332

(51) Int. Cl. G06F 16/583; G06N 3/08; G06F 16/587; G06F 16/58

(52) U.S. Cl. CPC G06F 16/5846; G06N 3/08; G06Q 50/01; G06F 16/5866; G06F 16/587

(57) ABSTRACT

There are provided information processing apparatus and method, and a program which can more accurately estimate user's preference.

An information processing apparatus comprises an image information acquisition unit that acquires an image associated with a user and accessory information including information on at least an imaging date of the image; a news information acquisition unit that acquires news information indicating contents of news distributed by a news site; an image analysis unit that analyzes image contents from the image; and an estimation unit that estimates a preference of the user on the basis of the image contents grasped by processing of the image analysis unit and the news information at a time corresponding to the imaging date.

### CROSS-REFERENCE TO RELATED APPLICATIONS

The present application claims priority under 35 U.S.C § 119 to Japanese Patent Application No. 2019-121332 filed on Jun. 28, 2019. The above application is hereby expressly incorporated by reference, in its entirety, into the present application.

### BACKGROUND OF THE INVENTION

### 1. Field of the Invention

The present invention relates to information processing apparatus and method, and a program, and particularly relates to an information processing technique of estimating user's preference from images owned by a user.

### 2. Description of the Related Art

JP2019-028793A discloses an information processing apparatus that downloads content data, which includes images posted on a server providing a social networking service (SNS), by a contributor and contributor's comments attached to the images, from the server and analyzes a preference tendency of the contributor.

JP2014-110001A discloses a technique of estimating a user's hobby and taste on the basis of behavior information, imaging information, captured images, text data posted on the SNS, and the like of the user.

JP2010-020719A discloses a technique of searching image groups stored in a storage site for an image, using tag information such as imaging date and time, an imaging location, and a name of a subject corresponding to an image, as candidates for image search keywords.

### SUMMARY OF THE INVENTION

In recent years, in electronic commerce sites or SNS advertisements, a recommendation system that recommends various products and/or services is operated. In such a recommendation system, it is possible to realize useful recommendation by correctly grasping user's preference. With the techniques disclosed in JP2019-028793A and JP2014-110001A user's preference can be roughly estimated, but it cannot be said that the estimation is always sufficient. For example, only by analyzing the image group, it is difficult to evaluate a preference level such as whether a degree of preference (preference degree) of a user is an enthusiastic level, which is extremely high or the like. In order to provide more appropriate information to each user, it is required to more accurately estimate user's preference.

The invention is made in view of such circumstances, and an object of the invention is to provide information processing apparatus and method, and a program which can more accurately estimate user's preference.

An information processing apparatus according to an aspect of the present disclosure comprises an image information acquisition unit that acquires an image associated with a user and accessory information including information on at least an imaging date of the image; a news information acquisition unit that acquires news information indicating contents of news distributed by a news site; an image analysis unit that analyzes image contents from the image; and an estimation unit that estimates a preference of the user on the basis of the image contents grasped by processing of the image analysis unit and the news information at a time corresponding to the imaging date.

The news information may be a news article distributed from the news site, and may be information on a specified matter or an extracted keyword from the contents of the news article. The user is an actual “person”, and typically, individual users are identified using unique identification information such as a user identification (ID). The term “user's preference” is not limited to an object of preference, but includes a concept such as a degree of a preference, a thing or matter that a user cares about, and a thing or matter important to a user.

According to the aspect, information which cannot be grasped only by the image analysis and the accessory information is acquired from the news site, and the user's preference is estimated by combining the image analysis result and the news information. Therefore, it is possible to more accurately estimate the user's preference, and give appropriate recommendation.

The information processing apparatus according to another aspect of the present disclosure may further comprise an associated information generation unit that generates information associated with the preference of the user estimated by the estimation unit.

For example, the information associated with the preference of the user may include information on a product or service to be recommended to the user. According to the aspect, it is possible to make an appropriate proposal to a user.

In another aspect of the present disclosure, the estimation unit may estimate a degree of the preference of the user from the news information.

The information processing apparatus according to another aspect of the present disclosure may further comprise a news search unit that extracts news associated with the image from distributed articles of a plurality of the news sites designated in advance, on the basis of the information on the imaging date.

In another aspect of the present disclosure, the accessory information may include information on an imaging location, and the news search unit may extract news associated with the image using the information on the imaging location.

It becomes easy to extract news associated with the image by using the information on the imaging location.

In another aspect of the present disclosure, the image analysis unit may include a word generation unit that generates a word associated with the image contents, and the news search unit may extract news associated with the image using the generated word.

The word associated with the image content may be a word indicating a name of an object shown in the image, a content of an event, or a location specified from a landmark building or the like. The “word” may be rephrased as a “keyword” or “wording”. The word generated by the word generation unit may be added to the accessory information of the image.

In another aspect of the present disclosure, the news search unit may extract news associated with the image by searching for news articles including a predetermined specific keyword.

The predetermined specific keyword may include at least one of crowd, rush, expensive, pricey, memorial day, anniversary, precious, or rare. The wording indicates that the degree of the preference is high or that the importance degree of the matter is high.

The information processing apparatus according to an aspect of the present disclosure may further comprise a storage device that stores a plurality of the images associated with the user; and an image search unit that searches an image group stored in the storage device for an image having high relevancy with the news information, in which the estimation unit estimates the preference of the user from an image hit by the search by the image search unit and the news information used for the search.

The information processing apparatus according to an aspect of the present disclosure may further comprise a news information list generation unit that collects news articles from a plurality of the news sites designated in advance, via the news information acquisition unit, and generates a news information list in which the news information including a date, a location, and an associated keyword is organized for each matter of the collected news articles.

In an aspect of the present disclosure, the image search unit may search the image group stored in the storage device for an image having high relevancy with the date, the location, and the associated keyword of the news information, and the estimation unit may estimate the preference of the user on the basis of the image hit by the search by the image search unit and the information used for the search.

In an aspect of the present disclosure, in a case where the news information on a news article including a predetermined specific keyword is listed in the news information list, the news information list generation unit may add identification information indicating a matter of the news article including the specific keyword.

In an aspect of the present disclosure, in a case where an image having high relevancy with the news information to which the identification information is added is hit by the search, the estimation unit may determine a degree of the preference of the user corresponding to the matter of the news information to which the identification information is added, from the identification information.

In an aspect of the present disclosure, the storage device may store a plurality of images associated with each of a plurality of users.

According to the aspect, it is possible to perform multifaceted information utilization such as analyzing a preference for each user, analyzing preference tendencies of a plurality of users by statistical processing, and classifying a plurality of users from the viewpoints of similarity of preferences.

In an aspect of the present disclosure, at least a part of the image analysis unit and the estimation unit may be configured by a learned model using a neural network.

For example, some or all of the object recognition processing of the image, processing of generating a word associated with the object, and the estimation processing of estimating the preference can be realized by using a learned model learned using deep learning.

An information processing method according to still another aspect of the present disclosure comprises, by an information processing apparatus configured using a computer, acquiring an image associated with a user and accessory information including information on at least an imaging date of the image; acquiring news information indicating contents of news distributed by a news site; analyzing image contents from the image; and estimating a preference of the user on the basis of the image contents grasped by processing of the analyzing and the news information at a time corresponding to the imaging date.

The information processing method according to another aspect of the present disclosure further includes generating information associated with the estimated preference of the user, by the information processing apparatus.

A program according to still another aspect of the present disclosure causes a computer to realize: a function of acquiring an image associated with a user and accessory information including information on at least an imaging date of the image; a function of acquiring news information indicating contents of news distributed by a news site; a function of analyzing image contents from the image; and a function of estimating a preference of the user on the basis of the image contents grasped by processing of the analyzing and the news information at a time corresponding to the imaging date.

An information processing apparatus according to still another aspect of the present disclosure comprises a processor, and a non-temporary computer-readable medium in which a command to be executed by the processor is stored, in which the processor executes the command to perform processing including acquiring an image associated with a user and accessory information including information on at least an imaging date of the image; acquiring news information indicating contents of news distributed by a news site; analyzing image contents from the image; and estimating a preference of the user on the basis of the image contents grasped by processing of the analyzing and the news information at a time corresponding to the imaging date.

According to the invention, since the user's preference is estimated by combining the image analysis result and the information on the news distributed from the news site, it is possible to more accurately estimate the user's preference.

### BRIEF DESCRIPTION OF THE DRAWINGS

FIG. 1 is an entire configuration diagram schematically illustrating an example of a computer system including an information processing apparatus according to an embodiment of the invention.

FIG. 2 is a functional block diagram illustrating a configuration example of an image preservation server.

FIG. 3 is a functional block diagram illustrating a configuration example of the information processing apparatus according to a first embodiment.

FIG. 4 is a flowchart exemplifying a procedure of an information processing method according to an embodiment of the invention.

FIG. 5 is a flowchart illustrating an example of processing by the information processing apparatus according to the first embodiment.

FIG. 6 is a diagram illustrating an example of an image group captured by a user.

FIG. 7 is a functional block diagram illustrating a configuration example of an information processing apparatus according to a second embodiment.

FIG. 8 is a table illustrating an example of a news information list that summarizes news information collected from a plurality of news sites.

FIG. 9 is a block diagram illustrating an example of a hardware configuration of a computer.

### DESCRIPTION OF THE PREFERRED EMBODIMENTS

Hereinafter, preferred embodiments of the invention will be described in detail with reference to the accompanying drawings.

Entire Configuration of Computer System

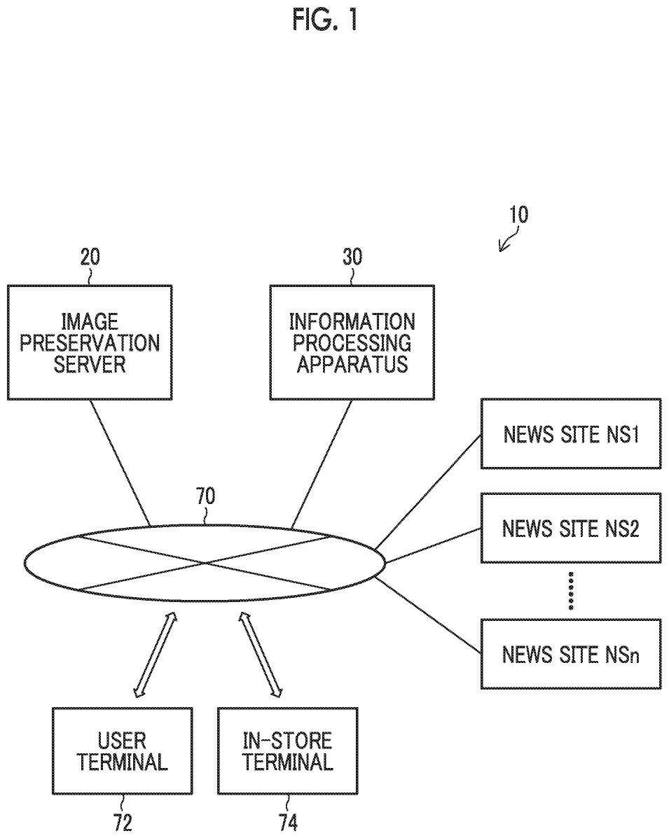

FIG. 1 is an entire configuration diagram schematically illustrating an example of a computer system including an information processing apparatus according to an embodiment of the invention. A computer system 10 illustrated in FIG. 1 is a system providing a cloud storage service that preserves image data, and includes an image preservation server 20, and an information processing apparatus 30. In FIG. 1, an example in which the image preservation server 20 and the information processing apparatus 30 are configured as separate devices is described, but functions thereof may be realized by one computer or may be realized by sharing processing functions between two or more of a plurality of computers.

The image preservation server 20 and the information processing apparatus 30 are connected to an electric telecommunication line 70. For example, the electric telecommunication line 70 may be a wide area network such as the Internet. The term “connected” includes not only wired connection but also a concept of wireless connection.

A user, who uses a cloud storage service in this example, is required to agree with predetermined terms of service before using the service to perform user registration. A user who has completed the user registration can upload image data to the image preservation server 20 by using an information terminal such as a user terminal 72 or an in-store terminal 74.

Each of the user terminal 72 and the in-store terminal 74 is a device having a communication function connectable to the electric telecommunication line 70. For example, the user terminal 72 may be a smart phone, a tablet terminal, or a personal computer owned by a user. The user terminal 72 is not limited to the property of a user, and the user terminal 72 may be a device shared by multiple people. The in-store terminal 74 is an information terminal installed in various stores such as a store providing a photo print service or convenience store. The in-store terminal 74 comprises a media interface for importing image data from an external storage device such as a memory card and/or a communication interface connectable to an external device. In FIG. 1, one user terminal 72 and one in-store terminal 74 are illustrated, but a plurality of user terminals 72 and a plurality of in-store terminals 74 can be connected to the electric telecommunication line 70.

The image preservation server 20 preserves and manages image data received from the user terminal 72 or the in-store terminal 74 by organizing the image data for each user.

The information processing apparatus 30 performs various kinds of information processing such as analyzing an image preserved in the image preservation server 20, generating tag information according to an image content such as an object or a scene of an image, or analyzing user's preference. The “image content” may be rephrased as “imaging content”. The processing function of the information processing apparatus 30 may be incorporated in the image preservation server 20.

A plurality of news sites NS1, NS2, . . . , and NSn are connected to the electric telecommunication line 70. The plurality of news sites NS1, NS2, . . . , and NSn are hereafter referred to as a “news site NS”. The news site NS includes a web server that distributes news articles. The information processing apparatus 30 collects information from a plurality of news sites NS which are designated in advance. It is preferable that the news sites NS designated in advance are site with high reliability of articles, and are news sites provided by, for example, national newspapers, local newspapers, news agencies or TV stations, or similar news media. Some of the plurality of news sites NS may be news distribution service sites performing news distribution by summarizing articles provided from a plurality of news providers.

The information processing apparatus 30 estimates a user's preference by using images preserved in the image preservation server 20 and news information obtained from the news site NS, and proposes various products and/or services according to the user's preference.

### Configuration Example of Image Preservation Server 20

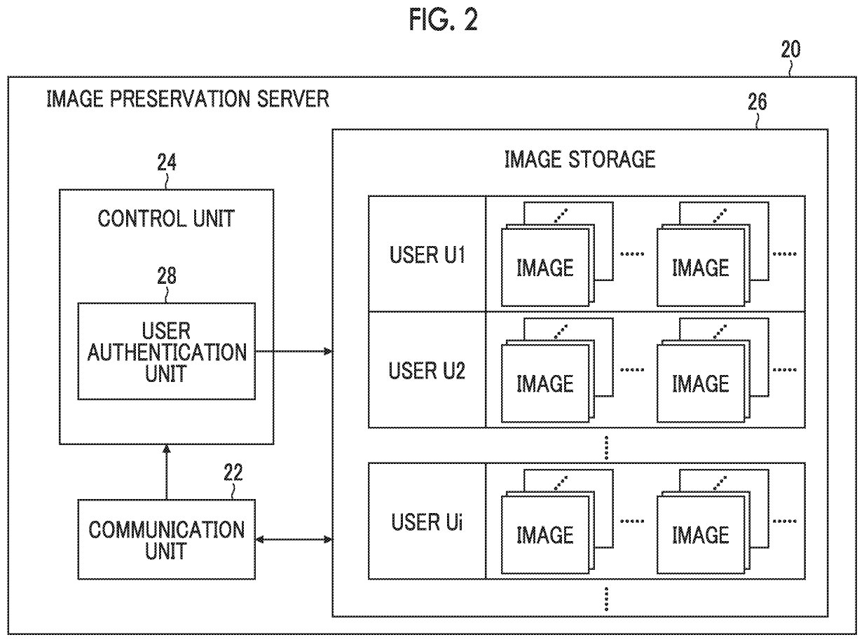

FIG. 2 is a functional block diagram illustrating a configuration example of the image preservation server 20. The image preservation server 20 comprises a communication unit 22, a control unit 24, and an image storage 26. The communication unit 22 is a communication interface for being connected to the electric telecommunication line 70. The control unit 24 controls data transfer performed via the communication unit 22. Further, the control unit 24 includes a user authentication unit 28, and controls data writing to the image storage 26 and data reading from the image storage 26. The user authentication unit 28 performs processing of user authentication.

The image storage 26 is a large-capacity storage device, and preserves images uploaded by users by organizing the images for each user. In a case where an index identifying each of a plurality of users is i, an image group held by a user Ui is preserved in the image storage 26 in association with information on the user Ui. For example, an image group held by a user U1 is preserved in the image storage 26 in association with information on the user U1. Similarly, an image group held by a user U2 is preserved in the image storage 26 in association with information on the user U2. An image group held by a user Ui may be preserved in the image storage 26 by being classified according to keywords such as an imaging date or imaging location.

The image preserved in the image storage 26 may be a digital photograph captured using an imaging device such as a digital camera or a smart phone, or may be an image obtained by converting an analog photograph into digital data. In a file of the image preserved in the image storage 26, accessory information relating to the image may be included. Further, the image preserved in the image storage 26 may be a video.

The accessory information includes at least one of, for example, information on imaging date and time, information on an imaging location, information on a name specifying a subject, information specifying a scene, information specifying an event where imaging is performed, information indicating a name of an object of the image, or information on a keyword to be used for search or classification of images. It is preferable that the accessory information includes at least information on the imaging date. It is more preferable that the accessory information includes information on imaging date and time and information on an imaging location. The accessory information includes a concept of tag information, metadata, and annotation.

The information on imaging date and time may be, for example, date and time information obtained from the built-in clock of the imaging device which is used for imaging, such as a digital camera or a smart phone. The information on the imaging location may be, for example, positional information obtained from a Global Positioning System (GPS) device built in the imaging device. The accessory information including the imaging date and time and the positional information is automatically added to the image captured using the imaging device which can record the imaging date and time and the positional information, and a file of the image including the accessory information is generated. In a case where disabling the use of positional information is set in the imaging device, the positional information is not recorded in the file of image, and information on the imaging date and time is recorded as the accessory information.

The accessory information is not limited to that automatically added by the imaging device or the like, and may specify at least one piece of information among the imaging date, the imaging time, and the imaging location by processing image data, or may be information that is input or edited by a user performing an input operation using an appropriate input interface as necessary. For example, it is possible to acquire information on the imaging date from the date information imprinted in the analog photograph. Further, for example, it is possible to specify the imaging location from a landmark building or the like detected using an object recognition technology by the image analysis. Some of the accessory information may be written by the information processing apparatus 30.

### Configuration Example of Information Processing Apparatus 30

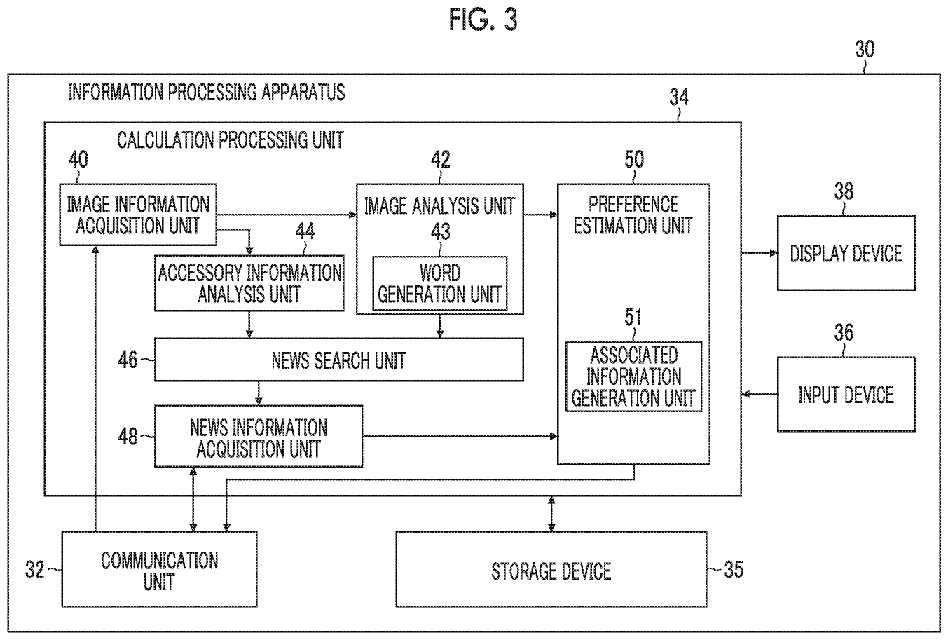

FIG. 3 is a functional block diagram illustrating a configuration example of the information processing apparatus 30 according to the first embodiment. The function of the information processing apparatus 30 is realized by a combination of software and hardware of the computer. The information processing apparatus 30 comprises a communication unit 32, a calculation processing unit 34, a storage device 35, an input device 36, and a display device 38.

The communication unit 32 is a communication interface for being connected to the electric telecommunication line 70. The calculation processing unit 34 is configured to include a central processing unit (CPU), for example. The calculation processing unit 34 includes an image information acquisition unit 40, an image analysis unit 42, an accessory information analysis unit 44, a news search unit 46, a news information acquisition unit 48, and a preference estimation unit 50. The calculation processing unit 34 performs various kinds of processing by using a storage area of the storage device 35.

The image information acquisition unit 40 includes an interface for importing data of images and accessory information. The image information acquisition unit 40 may be configured to include a data input terminal for importing data of images and accessory information from other signal processing units external to or inside the device. The image information acquisition unit 40 may be integrated with the communication unit 32. The image information acquisition unit 40 acquires images and accessory information from the image preservation server 20 via the communication unit 32. The image information acquisition unit 40 may acquire images and accessory information from the user terminal 72 or the in-store terminal 74.

The image acquired via the image information acquisition unit 40 is sent to the image analysis unit 42. The image analysis unit 42 performs processing such as scene analysis and object recognition on the input image. The image analysis unit 42 includes a word generation unit 43. The word generation unit 43 generates a word relating to the image content such as an event or the name of an object shown in the image. The word generated by the word generation unit 43 may be added to the accessory information as tag data of the image. The image group can be automatically classified on the basis of the word generated by the word generation unit 43. The analysis result of the image analysis unit 42 is sent to the news search unit 46 and the preference estimation unit 50.

The accessory information acquired via the image information acquisition unit 40 is sent to the accessory information analysis unit 44. The accessory information analysis unit 44 extracts information, which is to be used to search for news articles, from the content of the accessory information. The accessory information analysis unit 44 extracts information on, for example, the imaging date, the imaging time, and the imaging location.

The news search unit 46 extracts news associated with the image from distributed articles of the plurality of news sites NS which are designated in advance, on the basis of at least the information on the imaging date. Since there is time difference between the date and time when a matter of the news has occurred and the date and time when a news article regarding the matter is distributed, in case of searching for or collecting information on the news articles, it is preferable to determine relevancy with a time range width of at least one day or preferably about several days, in consideration of such a time difference.

It is preferable that the news search unit 46 extracts news associated with the image by using the information on the imaging location in addition to the information on the imaging date. In addition, it is preferable that the news search unit 46 extract news associated with the image by using the word generated by the word generation unit 43. Further, the news search unit 46 may extract news associated with the image by searching for news articles including a specific keyword which is determined in advance.

The news information acquisition unit 48 acquires news information indicating the content of the news distributed by the news site NS. The news information acquisition unit 48 includes an interface for importing data of the news article from the news site NS. The news information acquisition unit 48 may be configured to include a data input terminal for importing data of images and accessory information from other signal processing units external to or inside the device. The news information acquisition unit 48 may be integrated with the communication unit 32. The news information acquisition unit 48 collects information from the news site NS via the communication unit 32.

The preference estimation unit 50 performs processing of estimating a user's preference on the basis of the image content grasped by the processing by the image analysis unit 42 and the news information at the time corresponding to the imaging date. Here, the “user's preference” includes a concept such as a preference tendency of a user, a degree of a preference, a thing or matter that a user cares about, and a thing or matter important to a user. The degree of a preference includes a preference level indicating whether the user is a significantly eagerer (or enthusiastic) fan, that is, a core fan, than ordinary people. The degree of a preference is referred to as a “preference degree” or a “core degree” in some cases.

The preference estimation unit 50 further comprises an associated information generation unit 51 that generates information associated with the estimated user's preference. The information associated with the preference includes recommendation information for proposing a product or service associated with the preference, for example. The associated information generation unit 51 in this example generates recommendation information for informing of a recommended product or service which is to be recommended to the user in association with the user's preference. The recommendation information generated by the preference estimation unit 50 is provided to the user terminal 72 or the like via the communication unit 32. The preference estimation unit 50 is an example of a “estimation unit” of the present disclosure.

At least a part of the image analysis unit 42 and the preference estimation unit 50 is configured by a learned model that learned a model using a neural network by machine learning. In the image analysis unit 42 and the preference estimation unit 50 of this example, a learned model learned by deep learning is used.

The storage device 35 includes a semiconductor memory inside the CPU, a main storage device (main memory), and an auxiliary storage device. The images and accessory information acquired from the image preservation server 20 are preserved in the storage device 35. The storage device 35 may be used as a part or all of the image storage 26. The image storage 26, the storage device 35, or a combination thereof is an example of a “storage device” of the present disclosure.

The input device 36 is configured by, for example, a keyboard, a mouse, a touch panel, or other pointing devices, or a sound input device, or an appropriate combination thereof. The display device 38 is configured by, for example, a liquid crystal display, an organic electro-luminescence (OEL) display, or a projector, or an appropriate combination thereof.

Summary of Information Processing Method

The information processing apparatus 30 estimates a user's preference on the basis of imaging contents and accessory information of images held by the user and news information corresponding thereto. Among the accessory information of the image, the information on the imaging date and the information on the imaging location can be used in case of extracting news information corresponding to the user's image from among a plurality of news articles distributed by the news sites. Further, the accessory information of the image can be used at the time of extracting an image corresponding to specific news information from among the image group.

The news information can be information including facts or matters that are difficult to be grasped from the image analysis. That is, the news information is useful information for evaluating a degree of a user's preference for the matters grasped from the image, and further is useful information for evaluating the importance of the image or the importance of the matters shown in the image.

The information processing apparatus 30 estimates the user's preference by using the news information corresponding to the image in addition to the information indicating the image content (imaging content) grasped by the image analysis so that the user's preference can be more accurately estimated as compare with a case where the news information is not used.

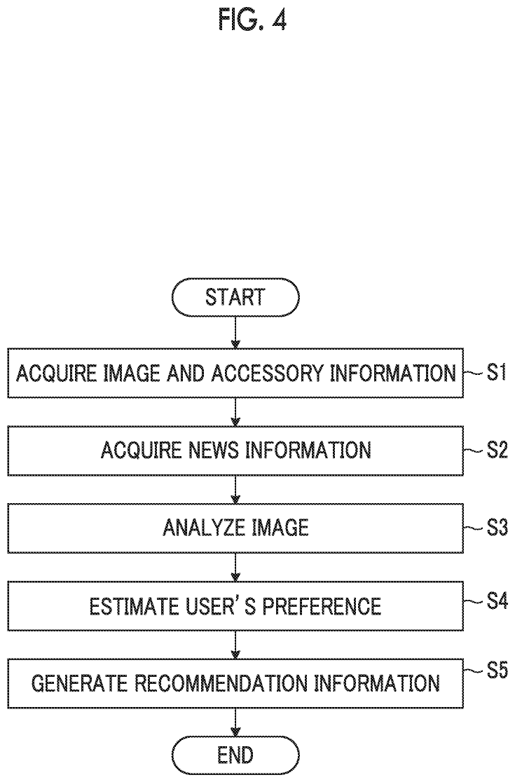

FIG. 4 is a flowchart exemplifying a procedure of an information processing method according to an embodiment of the invention. Each step of FIG. 4 can be realized by a computer functioning as the information processing apparatus 30 executing a program.

The information processing method according to the embodiment includes acquiring an image and accessory information by the information processing apparatus 30 (step S), acquiring news information by the information processing apparatus 30 (step S2), performing image analysis by the information processing apparatus 30 (step S3), estimating a user's preference by the information processing apparatus 30 (step S4), and generating recommendation information by the information processing apparatus 30 (step S5).

In step S1, the information processing apparatus 30 acquires an image held by a specific user and accessory information of the image from the image preservation server 20. Here, the “specific user” refers to a target person of which the preference is to be estimated.

In step S2, the information processing apparatus 30 acquires news information from news sites. For example, the information processing apparatus 30 acquires information on news articles which are distributed at the time corresponding to the imaging date on the basis of the accessory information of the image. The “time corresponding to the imaging date” may be the same date as the imaging date or may be a range of several days before and after the imaging date, including the imaging date. Here, the information on the news articles is acquired on the basis of the “imaging date”, but the information on the news articles may be collected on the basis of the imaging date and time including also the information on time.

In step S3, the information processing apparatus 30 analyzes the image acquired in step S1. The step of the image analysis includes processing of detecting a subject by object recognition and processing of generating a keyword associated with the detected object. The algorithm of the image analysis may be a learned neural network model learned using machine learning.

The information processing apparatus 30 performs analysis on at least one image of the image group held by the user, preferably a plurality of images, more preferably all of the images.

In step S4, the information processing apparatus 30 estimates a user's preference on the basis of the image analysis result obtained in step S3 and the news information obtained in step S2. The algorithm of the preference estimation may be a learned neural network model learned using machine learning.

In step S5, the information processing apparatus 30 generates recommendation information according to the user's preference estimated in step S4. The recommendation information generated in step S5 is output from the information processing apparatus 30, and is displayed on a display screen of the user terminal 72, for example. After step S5, the information processing apparatus 30 ends the flowchart of FIG. 4.

The information processing apparatus 30 executes the flowchart of FIG. 4 for each user, so that it is possible to provide appropriate recommendation information according to the preference of each user.

### Example of Processing Flow by Information Processing Apparatus 30 According to First Embodiment

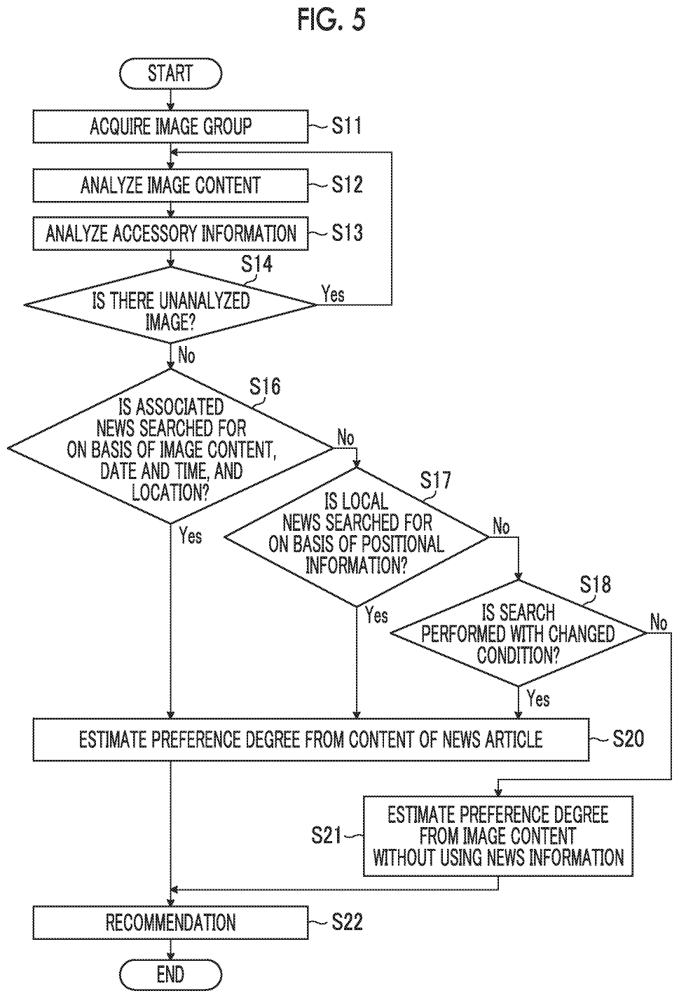

A more detailed example will be described using FIG. 5. FIG. 5 is a flowchart illustrating an example of processing by the information processing apparatus 30 according to the first embodiment.

In step S11, the information processing apparatus 30 acquires an image group held by a user. The information processing apparatus 30 may acquire the image group from the image preservation server 20 or may acquire the image group from the user terminal 72 or the in-store terminal 74. The acquired image group is stored in the storage device 35.

In step S12, the information processing apparatus 30 analyzes the image content of each image included in the acquired image group. The processing of step S12 is performed by the image analysis unit 42.

In step S13, the information processing apparatus 30 analyzes accessory information of the image. The processing of step S13 is performed by the accessory information analysis unit 44. The order of step S12 and step S13 may be interchanged, or step S12 and step S13 may be processed in parallel with each other.

In step S14, the calculation processing unit 34 of the information processing apparatus 30 determines whether there is an unanalyzed image. In a case where there is an image, on which the analysis processing of step S12 and step S13 has not been performed, of the image group acquired in step S11, the calculation processing unit 34 returns to step S12. In a case where analysis of step S2 and step S13 is performed on all of the images so that the determination result of step S14 is No, the calculation processing unit 34 proceeds to step S16.

In step S16, the calculation processing unit 34 search associated news on the basis of the image content, the date and time, and the location grasped in step S12 and step S13, and determines whether news information associated with the image is extracted.

In a case where the determination result of step S16 is Yes, that is, in a case where the news information associated with the image is extracted, the calculation processing unit 34 proceeds to step S20. In a case where the determination result of step S16 is No, that is, in a case where the news information associated with the image is not extracted, the calculation processing unit 34 proceeds to step S17. In step S7, the calculation processing unit 34 searches local news on the basis of the positional information of the image, and determines whether the news information associated with the image is collected.

In a case where the determination result of step S17 is Yes, the calculation processing unit 34 proceeds to step S20. In a case where the determination result of step S17 is No, the calculation processing unit 34 proceeds to step S18. In step S18, the calculation processing unit 34 further searches associated news with a changed search condition, and determines whether the news information associated with the image is collected. In step S18, for example, searching is performed by ignoring the information on the imaging date and only using the image content or the information on the location. In a case where the determination result of step S18 is Yes, the calculation processing unit 34 proceeds to step S20. In a case where the determination result of step S18 is No, the calculation processing unit 34 proceeds to step S21.

In step S20, the calculation processing unit 34 estimates the user's preference degree on the basis of the content of the news article extracted in any step of steps S16 to S18. In a case where there is a news article corresponding to the image, it is possible to evaluate the user's preference degree which cannot be grasped from the image content.

In step S21, the calculation processing unit 34 estimates the user's preference degree from the image content without using the news information. The processing of step S20 and step S21 is performed by the preference estimation unit 50. After step S20 or step S21, the calculation processing unit 34 proceeds to step S22.

In step S22, the calculation processing unit 34 generates recommendation information according to the estimated user's preference degree. The processing of step S22 is performed by the associated information generation unit 51. The recommendation information generated in step S22 is output from the information processing apparatus 30, and is provided to the user terminal 72 or the like. After step S22, the information processing apparatus 30 ends the flowchart of FIG. 5.

The information processing apparatus 30 executes the flowchart of FIG. 5 for each user, so that it is possible to provide appropriate recommendation information according to the preference of each user.

### Specific Example 1

Hereinafter, an operation of the information processing apparatus 30 will be described using a specific example. As a result of analyzing the imaging contents of the images held by the user U, keywords such as a “leisure facility T”, a “character M”, a “parade” were automatically generated. Each of the “leisure facility T” and the “character M” is the real name. In addition, from the accessory information of the image, the imaging date was “November, 18” and the imaging location was the “leisure facility T”.

After searching for the articles of the news sites by using these keywords, the following news article was extracted.

“[News Article] Character M, a popular character celebrating its 90th anniversary on November 18. In the leisure facility T, visitors rushed to attractions inside the facility to celebrate the character M's birthday, causing an unusual situation of waiting up to 11 hours. Customers are complaining about the strange scene of ‘Dreamland’.”

In a case where the user's preference is analyzed in consideration of the contents of the news article, it is estimated that the user U is a core fan for the leisure facility T and/or the character M. That is, according to the contents of the news article, the user U visited the leisure facility T on a special anniversary of the 90th anniversary of birth despite the disadvantage of heavy congestion of waiting up to 11 hours for ordinary people to hesitate. Such behavior of the user U can be evaluated as indicating that the degree of the preference for the leisure facility T and/or the character M is extremely high. Further, it is considered that the image of the photograph is a precious scene of an anniversary of the 90th anniversary of birth, and is highly likely a particularly important matter for the user U.

Therefore, for the user U, it is possible to take a measure such as recommending associated products of the leisure facility T and/or the character M that the user U wants to buy because of being a core fan, or recommending a product and/or service associated with a special anniversary.

### Specific Example 2

As a result of analyzing imaging contents of images held by a certain user U, a keyword such as a “watching soccer” was automatically generated. In addition, from the accessory information of the image, the imaging date was “October, 31” and the imaging location was the “Shinjuku”. After searching for the articles of the news sites by using a word included in the keywords, the following news article was extracted.

“[News Article] By the Japanese national team who have won Australia in the Asian final qualifying round of the Football World Cup held on the 31st and decided to participate in the main tournament, the archipelago is excited! At the scramble intersection in front of Shibuya Station in Tokyo, a large number of supporters, especially young people, rushed in and became turbulent immediately after the end of the game. The Tokyo Metropolitan Police Department has guarded to prevent trouble.”

As a result of searching for news, new associated with the positional information on the imaging location of “Shinjuku” was not extracted but a news article associated with “soccer” was extracted. In a case where the user's preference is analyzed in consideration of the contents of the news article, it is estimated that the user U is a soccer fan. That is, from the contents of the news article, it is considered that the image of the photograph is an important game watching scene of the Asian final qualifying round that decided the main tournament, and is highly likely a particularly important matter for the user U. Therefore, for the user U, it is possible to take a measure such as recommending associated products of soccer, or recommending associated products of the game that the user U watched and/or associated products of the tournament.

### Using Example 1 of News Information

It is possible to recognize what kind of object is shown in each image by using the object recognition technology by the image analysis. For example, it is possible to recognize what kind of character is shown in each image. Here, it is assumed that three kinds of characters of a character A, a character B, and a character C are recognized from the image group held by a certain user. It is assumed that each of the character A, the character B, and the character C actually has a proper noun.

However, it is difficult to evaluate which character is more important to the user only by the result of the image analysis. Note that in a “user” in case of being important to the user, a person who is close to the user, such as a user's family may be included.

Here, in the embodiment, online news articles are searched for using the object recognition, the accessory information, and the like of the image as search items, and the contents of the news articles are used to evaluate the degree of the preference.

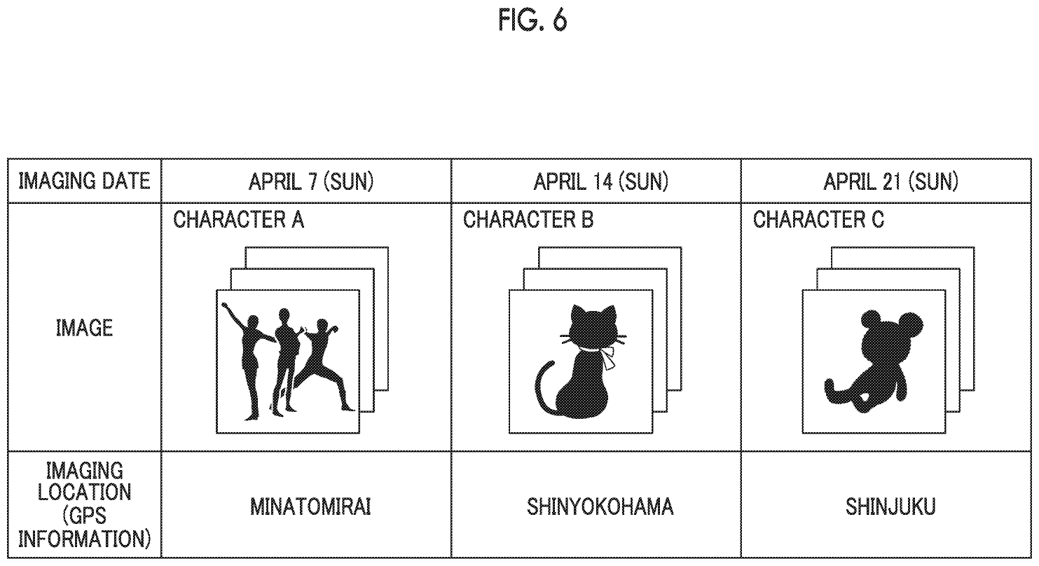

FIG. 6 is an example of image groups held by a certain user. The imaging date is specified from the accessory information. The discrimination of the character A, the character B, and the character C shown in the images is specified by the object recognition. The imaging location is specified from the GPS information included in the accessory information, for example. In a case where the GPS information is not included in the accessory information, when a location can be discriminated from recognition of a landmark building by object recognition or information on a mobile phone base station, information on the discriminated location may be used.

The news search unit 46 search an article group of a plurality of news sites NS designated in advance for each keyword of the “imaging date”, the “character name”, and the “imaging location” using the “AND condition”. For example, in the example of FIG. 6, searching is performed using the following search expressions.

Search Expression 1: “April 7”*“Character A”*“Minatomirai”

Search Expression 2: “April 14”*“Character B”*“Shinyokohama”

Search Expression 3: “April 21”*“Character C”*“Shinjuku”

As a result, for example, it is assumed that there is no corresponding article in “Search Expression 3” and thus there is no search result, but in each of “Search Expression 1” and “Search Expression 2”, there is a corresponding article and thus there is a search result. In such a case, it can be estimated that capturing images of the character A at Minatomirai and capturing images of the character B at Shinjuku by the user or a family including the user are more intentional than capturing images of the character C on another day (April 21). In this manner, it is possible to extract the character A and the character B as what the user cares about. Here, as the imaging date, “month/day” is used, but “year/month/day” including “year” may be used.

### Using Example 2 of News Information

In case of search using Search Expressions 1 to 3 described above, whether there is an article including specific wording is further searched for using “AND condition” in each of Search Expressions 1 to 3. The specific wording refers to a “specific keyword”. The specific keyword is, for example, a word as follows.

Specific Keywords: {crowd, rush, expensive, pricey, memorial day, anniversary, precious, rare}

These specific keywords indicate that the degree of the user's preference is extremely high. The specific keywords are determined in advance. Regarding the matter of news articles including wording of “crowd” or “rush”, it is possible to infer the user's positive willingness to “want to see even when crowded”. Regarding the matter of news articles including wording of “expensive” or “pricey”, it is possible to infer the user's positive willingness to “want to see even if expensive, or want to buy even if expensive”. Regarding the matter of news articles including wording of “memorial day” or “anniversary”, it is possible to infer the user's positive willingness to “want to go to a special commemorative event and celebrate because of being a core fan”. Regarding the matter of news articles including wording of “precious” or “rare”, it is possible to infer the user's positive willingness to “want to see or get it because of being a core fan”.

### Example of Other Useful Information for Estimation of Preference

The preference estimation unit 50 may use information on at least one of an imaging frequency or an imaging interval other than the information on the image content, the imaging date and time, and the imaging location in case of estimating the user's preference. For example, in a case where a lot of images are captured in a short time interval, it is considered that a degree of interest in the imaging content is high. Further, in a case where the imaging frequency for a certain object is high, it is considered that a degree of interest is high.

### Example of Providing Recommendation Information

The information processing apparatus 30 specifies a product and/or service associated with the estimated user's preference, and recommends the product and/or service to the user. The time for recommendation is a certain period of time (for example, one year) from the imaging date when the number of images is large. The recommendation may be ended after a certain period of time elapses. It is preferable that the time for recommendation is appropriately adjust depending on the type of products and/or services to be proposed.

The associated information generation unit 51 may attach information indicating a discount or price reduction in case of recommending a product and/or service.

Further, in a case where the same event occurs consecutively, the information processing apparatus 30 stores the number of occurrences, and in a case where it is detected that the same event has not occurred even after a predetermined period time, the information processing apparatus 30 may determine a discount rate or a discount amount on the basis of the number of occurrences.

### Second Embodiment

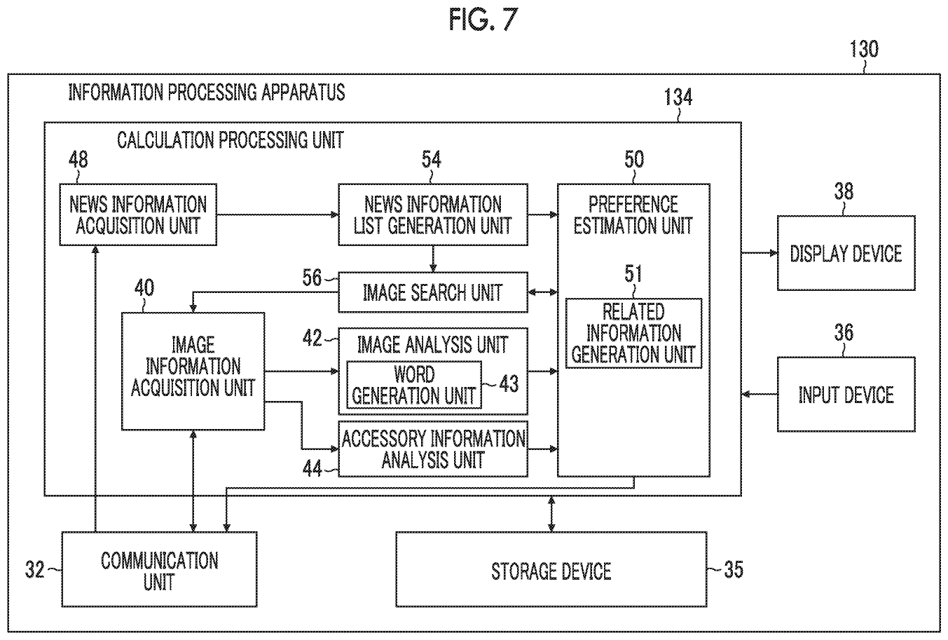

FIG. 7 is a functional block diagram illustrating a configuration example of an information processing apparatus 130 according to a second embodiment. Instead of the information processing apparatus 30 described in FIG. 3, the information processing apparatus 130 illustrated in FIG. 7 may be adopted. In FIG. 7, the same or similar elements to the configuration illustrated in FIG. 3 are given the same reference numerals, and descriptions thereof will be omitted. Regarding the information processing apparatus 130 illustrated in FIG. 7, the difference point from the information processing apparatus 30 according to the first embodiment will be described. The information processing apparatus 30 according to the first embodiment illustrated in FIG. 3 is configured to collect information from news sites by using the accessory information of the image and/or the analysis result of the image. In contrast, the information processing apparatus 130 according to the second embodiment illustrated in FIG. 7 is configured to collect information on news from the news sites NS in advance, and search for an image having high relevancy with the date, time, location, and keyword of the listed news.

The information processing apparatus 130 comprises a calculation processing unit 134 instead of the calculation processing unit 34. As illustrated in FIG. 7, the calculation processing unit 134 comprises a news information list generation unit 54, and an image search unit 56.

The news information list generation unit 54 generates a news information list from the news articles acquired via the news information acquisition unit 48. The news information list is a list in which the date, time, location, and keyword are organized for each content of the news article. The news information used in preference estimation is not limited to the news article itself, and may be information processed (edited) on the basis of the news article such as the information listed in the news information list.

The image search unit 56 searches the image groups preserved in the image preservation server 20 for the image having high relevancy with the date, time, location, and keyword listed in the news information list. In case of performing image search, it is preferable that tag data such as a keyword associated with the image content is added to each image. The tag data can be generated by the word generation unit 43. The search result of the image search unit 56 is sent to the preference estimation unit 50.

The preference estimation unit 50 estimates the user's preference from the images extracted by the image search unit 56 and generates recommendation information associated with the estimated user's preference. The function of the image search unit 56 may be incorporated in the preference estimation unit 50. A specific example of processing by the information processing apparatus 130 will be described.

### Using Example 3 of News Information

Since the number of news sites NS is finite, the information processing apparatus 130 collects all of information on the matters, for example, events occurred in Japan and information on the launch of a new product or service, from a plurality of news sites NS for each day. Here, news “in Japan” is exemplified, but information may be collected from news sites of a plurality of countries, and information may be collected from news sites around the world. The range of the country or region from which news information is collected may be designated in advance.

Regarding a timing at which information is collected from the news site NS, for example, since it is considered that the events occurring on Sunday are distributed as news on that day or the next Monday in many cases, it is assumed that information relating to the events occurring on Sunday is collected on Tuesday. The information processing apparatus 130 collects the date, occurrence time (time zone), location and associated keywords, for each matter of the news.

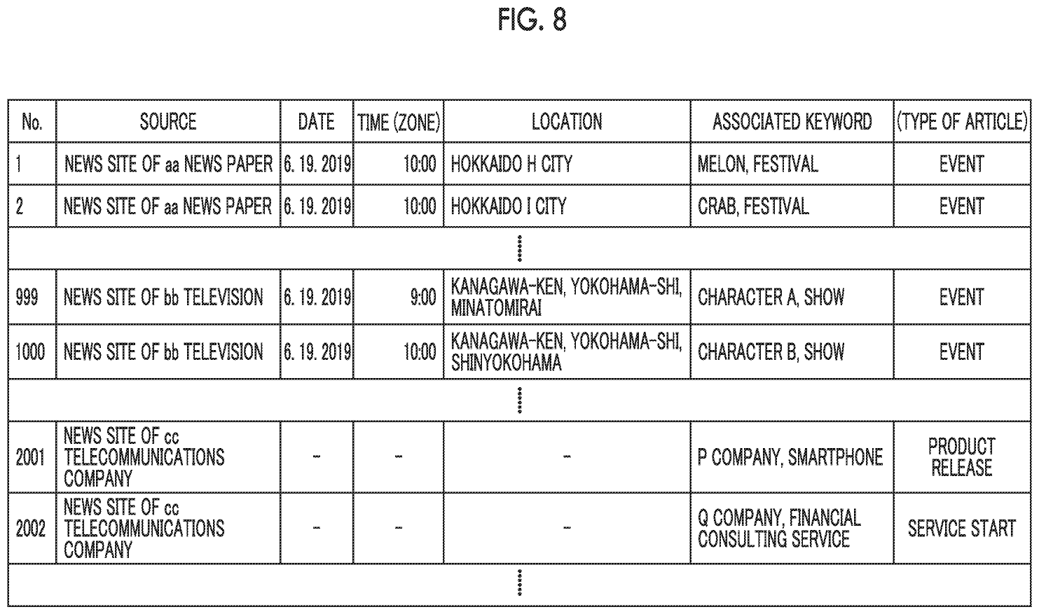

FIG. 8 is a table illustrating an example of the news information list. The news information list generation unit 54 generates the news information list as in FIG. 8, for example. The news reporting the release of a new product such as “No. 2001” in FIG. 8 is a matter not relating to a “location”, but it is considered that the user gets the newly released product and takes a photo of the product.

For the news reporting the service start such as “No. 2002” or the like, it may be difficult to think of associated images, but since it may be technically difficult to perform an operation of excluding news articles having poor relevancy with the image, the information may be listed without performing excluding processing at the time of information collection. In a case where there is no image associated with No. 2002 in the image groups preserved online, since there is no problem in terms of the system with the image search result of “not applicable”, the information processing apparatus 130 may mechanically collect news articles.

Information for classifying the types of articles may be added to the news information list. The news information list generation unit 54 can generate words for classifying the types of articles from the contents of the news.

The information processing apparatus 130 searches all image groups, which are preserved online, of all of the users of the present system on the day for collecting information, for images having high relevancy with the time, location, and keyword listed above. For the images hit by the image search, it can be known that the item indicated by the keyword used for the search is what the user who holds the image, takes care about.

### Using Example 4 of News Information

In case of listing the news information in “Using Example 3 of News Information”, a flag is set for the news article including a predetermined specific keyword. In a case where an image associated with the article with the flag is hit, it can be known that the user, who holds the image, is a core fan for the associated keyword.

The specific keywords are wording indicating that the degree of the user's preference is extremely high similarly to “Using Example 2 of News Information”, and may be, for example, {crowd, rush, expensive, pricey, memorial day, anniversary, precious, rare}.

The news information list generation unit 54 performs processing of determining whether specific wording is included in the news article, and assigning a flag according to the determination result. The information on the flag is included in the news information list. The flag is an example of “identification information” of the present disclosure.

Method of Providing Appropriate Recommendation to User

As specifically described in “Using Examples 1 to 4 of News Information”, according to the embodiment of the invention, it is possible to evaluate an importance degree of the object in the image to the user. That is, each object specified by the image analysis can be classified into the following [1] to [3]. That is, each object can be classified into [1] an object appearing multiple times in images, [2] an object considered to be important to the user, and [3] an object for which the user is a core fan.

These classifications correspond to the user's preference level for the object. In a case where for an object classified into any one of [1] to [3], recommendation of a product and/or service associated with the object is provided, it is preferable to make the content, frequency, and number of the recommendation to be provided different according to the classifications of [1] to [3].

For example, as the degree of importance is greater, the frequency of the recommendation for the object is increased. As the degree of importance is greater, an event that takes place in a more distant area is recommended. As the degree of importance is greater, a more expensive product and/or service is recommended. Such different ways are considered.

Regarding Protection of Personal Information on User

<1> The system administrator of the embodiments of the invention shall obtain consent from the user regarding analyzing user's images and sending recommendation from the analysis result.

<2> The main agent who sends recommendation of a product and/or service, which a provider of a certain product and/or service wants to recommend, to a user may be the system administrator or may be a provider of a product and/or service.

<3> In a case where a provider of a product and/or service is the main agent who sends recommendation to a user, consent regarding transferring information, which is required for sending recommendation to a user, to the provider of the product and/or service shall be obtained from the user. It is preferable that the information required for sending recommendation is minimum necessary information such as a mail address.

<4> In providing information such as analyzing images of a plurality of user to send subjects imaged multiple times to the affiliation company, user information and information specifying a user are not provided. Further, consent regarding providing information after anonymizing the information is obtained from the user in advance.

### Example of Hardware Configuration of Computer

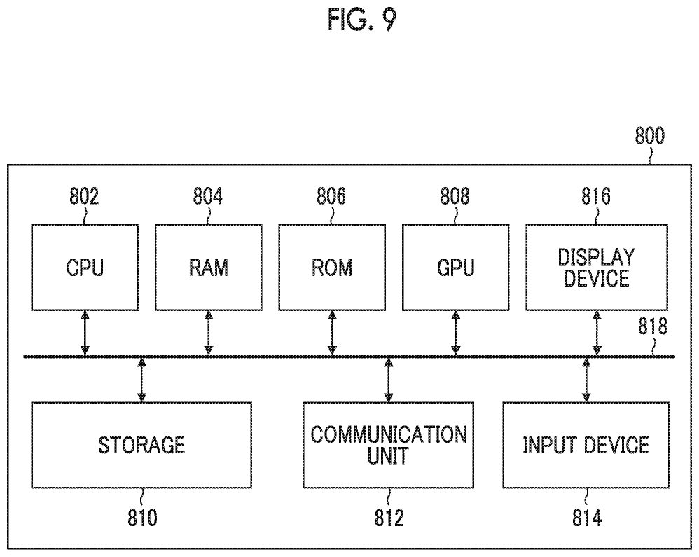

FIG. 9 is a block diagram illustrating an example of a hardware configuration of a computer. A computer 800 may be a personal computer, a workstation, or a server computer. The computer 800 can be used as a device implementing functions of the image preservation server 20, the information processing apparatus 30, the user terminal 72, and the in-store terminal 74 described above.

The computer 800 comprises a central processing unit (CPU) 802, a random access memory (RAM) 804, a read only memory (ROM) 806, a graphics processing unit (GPU) 808, a storage 810, a communication unit 812, an input device 814, a display device 816, and a bus 818. The GPU 808 may be provided as necessary, and if the calculation load is not great, the GPU 808 may be omitted.

The CPU 802 reads various programs stored in the ROM 806 or the storage 810 to execute the various kinds of processing. The RAM 804 is used as a work area of the CPU 802. Further, the RAM 804 is used as a storage unit that temporarily stores the read program and various kinds of data.

The storage 810 includes, for example, a storage device configured using a hard disk device, an optical disk, a magneto-optical disk, or a semiconductor memory, or an appropriate combination thereof. The storage 810 stores various programs or data required for learning processing, image analysis processing, and/or preference estimation processing, and other various kinds of processing. The program stored in the storage 810 is loaded on the RAM 804 to be executed by the CPU 802, so that the computer functions as a unit that performs various kinds of processing defined by the program.

The communication unit 812 is an interface for performing communication processing with external devices in a wired or wireless manner, and exchanging information with the external devices.

The input device 814 is an input interface for receiving various operation inputs to the computer 800. The input device 814 is configured by, for example, a keyboard, a mouse, a touch panel, or other pointing devices, or a sound input device, or an appropriate combination thereof.

The display device 816 is an output interface for displaying various kinds of information. The display device 816 is configured by, for example, a liquid crystal display, an organic electro-luminescence (OEL) display, or a projector, or an appropriate combination thereof.

Regarding Program Operating Computer

A program that causes a computer to realize some or all of at least one processing function of the image preservation server 20, the information processing apparatus 30, and the information processing apparatus 130 described in the embodiments can be recorded on a computer-readable medium as a tangible non-temporary information storage medium such as an optical disk, a magnetic disk, or a semiconductor memory, and the program can be provided via the information storage medium.

Further, instead of an aspect in which the program is provided by being stored in the tangible non-temporary information storage medium, a program signal can be provided as a download service using an electric telecommunication line such as the Internet.

Some or all of at least one processing function of the image analysis function, the preference estimation function, and the recommendation providing function described in the embodiments can be provided as an application server, and a service providing the processing function through an electric telecommunication line can be performed.

Regarding Hardware Configuration of Each Processing Unit

Hardware structures of processing units which execute various kinds of processing of the control unit 24, the user authentication unit 28, the image information acquisition unit 40, the image analysis unit 42, the word generation unit 43, the accessory information analysis unit 44, the news search unit 46, the news information acquisition unit 48, the preference estimation unit 50, the associated information generation unit 51, the news information list generation unit 54, and the image search unit 56 which are described in FIGS. 2, 3, and 7 are various processors described below, for example.

The various processors include, for example, a CPU that is a general-purpose processor which executes a program to function as various processing units, a GPU that is a processor specialized for image processing, a programmable logic device (PLD) that is a processor of which the circuit configuration can be changed after manufacture, such as a field-programmable gate array (FPGA), and a dedicated electric circuit that is a processor having a dedicated circuit configuration designed to execute a specific process, such as an application specific integrated circuit (ASIC).

One processing unit may be configured by one processor among these various processors, or may be configured by two or more same or different kinds of processors. For example, one processing unit may be configured by a plurality of FPGAs, a combination of a CPU and a FPGA, or a combination of a CPU and a GPU. In addition, a plurality of processing units may be configured by one processor. As an example where a plurality of processing units are configured by one processor, first, there is an aspect where one processor is configured by a combination of one or more CPUs and software as typified by a computer, such as a client or a server, and this processor functions as a plurality of processing units. Second, there is an aspect where a processor fulfilling the functions of the entire system including a plurality of processing units by one integrated circuit (IC) chip as typified by a system on chip (SoC) or the like is used. In this manner, various processing units are configured by using one or more of the above-described various processors as hardware structures.

Furthermore, the hardware structures of these various processors are more specifically electrical circuitry where circuit elements, such as semiconductor elements, are combined.

### Modification Example 1

The storage service using the image preservation server 20 and the recommendation service using the information processing apparatus 30 may be managed and operated by different system administrators (for example, different companies).

### Modification Example 2

The function of the image analysis unit 42 of the information processing apparatuses 30 and 130 may be mounted in the image preservation server 20.

### Modification Example 3

The image associated with the user is not limited to the image which is preserved in the image preservation server 20 and is held by the user, and may be a posted image which is posted on the SNS server.

Others

The configurations described in the embodiments and the matters described in the modification examples can be combined to be used as appropriate, and some matters can be replaced.

In the embodiments of the invention described above, configuration requirements can be changed, added, or deleted as appropriate in a range without departing from the gist of the invention. The invention is not limited to the embodiments described above, and many modifications are possible by a person with ordinary skill in the equivalent related art within the technical idea of the present invention.

### EXPLANATION OF REFERENCES

10: computer system
20: image preservation server
22: communication unit
24: control unit
26: image storage
28: user authentication unit
30: information processing apparatus
32: communication unit
34: calculation processing unit
35: storage device
36: input device
38: display device
40: image information acquisition unit
42: image analysis unit
43: word generation unit
44: accessory information analysis unit
46: news search unit
48: news information acquisition unit
50: preference estimation unit
51: associated information generation unit
54: news information list generation unit
56: image search unit
70: electric telecommunication line
72: user terminal
74: in-store terminal
130: information processing apparatus
134: calculation processing unit
800: computer
810: storage
812: communication unit
814: input device
816: display device
818: bus
S1 to S5: step of information processing method
S11 to S22: step of processing by information processing apparatus according to first embodiment

What is claimed is:

1. An information processing apparatus comprising:
an image information acquisition unit that acquires an image associated with a user and accessory information including information on at least an imaging date of the image;
a news information acquisition unit that acquires news information indicating contents of news distributed by a news site;
an image analysis unit that analyzes image contents from the image; and
an estimation unit that estimates a preference of the user on the basis of the image contents grasped by processing of the image analysis unit and the news information at a time corresponding to the imaging date.

2. The information processing apparatus according to claim 1, further comprising:
an associated information generation unit that generates information associated with the preference of the user estimated by the estimation unit.

3. The information processing apparatus according to claim 2,
wherein the information associated with the preference of the user includes information on a product or service to be recommended to the user.

4. The information processing apparatus according to claim 1,
wherein the estimation unit estimates a degree of the preference of the user from the news information.

5. The information processing apparatus according to claim 1, further comprising:
a news search unit that extracts news associated with the image from distributed articles of a plurality of the news sites designated in advance, on the basis of the information on the imaging date.

6. The information processing apparatus according to claim 5,
wherein the accessory information includes information on an imaging location, and
the news search unit extracts news associated with the image using the information on the imaging location.

7. The information processing apparatus according to claim 5,
wherein the image analysis unit includes a word generation unit that generates a word associated with the image contents, and
the news search unit extracts news associated with the image using the generated word.

8. The information processing apparatus according to claim 5,
wherein the news search unit extracts news associated with the image by searching for news articles including a predetermined specific keyword.

9. The information processing apparatus according to claim 8,
wherein the predetermined specific keyword includes at least one of crowd, rush, expensive, pricey, memorial day, anniversary, precious, or rare.

10. The information processing apparatus according to claim 1, further comprising:
a storage device that stores a plurality of the images associated with the user; and
an image search unit that searches an image group stored in the storage device for an image having high relevancy with the news information,
wherein the estimation unit estimates the preference of the user from an image hit by the search by the image search unit and the news information used for the search.

11. The information processing apparatus according to claim 10, further comprising:
a news information list generation unit that collects news articles from a plurality of the news sites designated in advance, via the news information acquisition unit, and generates a news information list in which the news information including a date, a location, and an associated keyword is organized for each matter of the collected news articles.

12. The information processing apparatus according to claim 11,
wherein the image search unit searches the image group stored in the storage device for an image having high relevancy with the date, the location, and the associated keyword of the news information, and
the estimation unit estimates the preference of the user on the basis of the image hit by the search by the image search unit and the information used for the search.

13. The information processing apparatus according to claim 11,
wherein in a case where the news information on a news article including a predetermined specific keyword is listed in the news information list, the news information list generation unit adds identification information indicating a matter of the news article including the specific keyword.

14. The information processing apparatus according to claim 13,
wherein in a case where an image having high relevancy with the news information to which the identification information is added is hit by the search, the estimation unit determines a degree of the preference of the user corresponding to the matter of the news information to which the identification information is added, from the identification information.

15. The information processing apparatus according to claim 10,
wherein the storage device stores a plurality of images associated with each of a plurality of users.

16. The information processing apparatus according to claim 1,
wherein at least a part of the image analysis unit and the estimation unit is configured by a learned model using a neural network.

17. An information processing method comprising:
by an information processing apparatus configured using a computer,
acquiring an image associated with a user and accessory information including information on at least an imaging date of the image;
acquiring news information indicating contents of news distributed by a news site;
analyzing image contents from the image; and
estimating a preference of the user on the basis of the image contents grasped by processing of the analyzing and the news information at a time corresponding to the imaging date.

18. The information processing method according to claim 17, further comprising:
generating information associated with the estimated preference of the user, by the information processing apparatus.

19. A non-transitory, tangible computer-readable storage medium which stores a program for causing a computer to realize:
a function of acquiring an image associated with a user and accessory information including information on at least an imaging date of the image;
a function of acquiring news information indicating contents of news distributed by a news site;
a function of analyzing image contents from the image; and
a function of estimating a preference of the user on the basis of the image contents grasped by processing of the analyzing and the news information at a time corresponding to the imaging date.
